(19) United States
(12) Patent Application Publication
(10) Pub. No.: US 2002/0139317 A1
(43) Pub. Date: Oct. 3, 2002

(54) Apparatus and method for controlling an animal

(76) Inventor: Wayne D. Schwartz, Spivey, KS (US)

Correspondence Address: Randall W. Schwartz, 1110 Gulfton, Pearland, TX, 77581, US

(21) Appl. No.: 09/824,450

(22) Filed: Apr. 2, 2001

(51) Int. Cl. A01K 37/00

(52) U.S. Cl. 119/712

(57) ABSTRACT

The present invention is directed toward an apparatus and method for controlling an animal, more typically a horse. The device includes a motorized and programmable actuator that is coupled to a bridle on the horse. The actuator is used to pull the bridle in a manner similar to how reins or a lead rope are used to control a horse. The actuator includes controls mounted directly on the actuator unit. The invention also includes a remote signal unit that sends control signals to the actuator so that a user located remotely from the horse can control the horse.

### BACKGROUND OF THE INVENTION

1. Field of the Invention

This invention is directed toward an apparatus and method for controlling an animal. More particularly, the invention is directed toward controlling an animal by a remotely controlled system The remotely controlled system comprises a remote control unit, which provides an input signal to an actuator. The actuator then provides a physical stimulus to the animal.

2. Description of the Prior Art

In the equestrian world, a bridle is standard rigging for controlling a horse during various activities. The bridle normally attaches to a set of reins, a lead rope, or a jerk-line for applying a controlling force. For use with horses, such rigging can be used with a rider in a mounted or dismounted state. When mounted, the rider may command the horse to stop or back up by pulling the reins toward the rider. The amplitude and duration of pull force also depend on the rider's desired maneuver as well as the horse's level of training and the horse's sensitivity to commands. Likewise, force applied on one rein represents a command to the horse to turn in a particular direction. The mounted rider typically sits on a saddle. The saddle normally includes a saddle horn for tying the reins or other ropes to the saddle.

The type of rider activity determines how to use such rigging. Typical activities may include training, pleasure riding, cattle ranching, and professional competitions like racing or rodeos. For instance, cattle ranching activities often require the rider to dismount the animal and do work while leaving the animal in a stationary position. Depending on the level of training, the horse may have to be secured to a rigid fence or post to keep the animal from walking away from the rider. Also in pleasure riding, an inexperienced rider may leave an animal unattended and allow the animal to walk away. Again the reins are often tied to a post or held by the rider to secure the animal For a trained horse, the rider may keep the horse steady by dropping the reins to the ground, a method referred to as “ground-tie”. For professional rodeo competitions like calf roping, the rider uses more sophisticated rigging such as a “jerk-line”. In competition, the rider must be able to rope a calf then quickly dismount the horse, proceed to a calf that may be as much as 20-30 feet in front of the horse, and tie the calf's legs while the horse maintains its position. In competition and training, the rider uses the jerk-line to pull the bridle after the rider dismounts the horse encouraging the horse to remain stationary or back up slightly. In competition, the pull is accomplished by tying an end of the line to the bit, feeding it through a pulley connected to the saddle horn and feeding the other end in a weave pattern between the rider's waist and belt. As the rider dismounts and runs forward to the calf, the jerk-line feeds out from the rider's waist and the friction involved causes a pull at the bit. The line is designed to feed completely out of the rider's waist and fall to the ground, thus the rider will lose control of the horse after that time. In training, the rider may simply stand to the side or in front of the horse and pull the jerk-line by hand causing the horse to stop or back up. Another type of rigging used for training purposes is referred to as a tether line. A tether line may be a lead rope from 20-50 feet long with one end tied to the bit and the other end held by a trainer, thus allowing the animal to move in an area without running away.

The use of such rigging has created several needs for an improved control device. Tying a horse with reins to a stationary structure may be inconvenient or impossible thus suggesting the need for another means for holding the horse steady. Also, for the rancher or pleasure rider, the reins or rope are of no use for stopping a horse that is wandering off and is out of the rider's reach; a device to help the rider stop and retrieve such a horse is desirable. The ground-tie method may result in the same situation if the horse is not properly trained or the ground-tie method also may cause the horse to panic if the horse steps on the reins, thus creating the need for a more reliable device. For competition use, the jerk-line is limited to a certain length of about 17 feet, and continued control of the horse is often not possible unless the rider retrieves a line out of his reach. Also, the jerk-line may develop an inconsistent pull on the bridle due to the nature of its use. Information relevant to attempts to address these problems can be found in U.S. Pat. No. 4,304,193 to Madden; 4,765,276 to Kime; and U.S. Pat. No. 5,566,645 to Cole. However, each of these suffers from one or more of the following technical and commercial disadvantages relative to the present invention: (a) the design does not solely address the foregoing needs; (b) the complexity does not allow for economical manufacture of a device that addresses the foregoing needs; (c) the complexity does not provide the user with an efficient interface; and (d) the device as illustrated is too large and cumbersome to be used with a saddle for the activities described above.

For the foregoing reasons, there has been a long-felt need for a horse controlling device that can be used with a typical saddle and can allow a rider to use the device while mounted or dismounted from the saddle. Another long-felt need has been for a device that is built solely for the purpose of stopping or backing up a horse. Another long-felt need has been for a device of this nature that is inexpensive to manufacture and therefore is a reasonable cost to the consumer. Yet another need for the device is that it be a rugged and robust design. These needs require the device to be lightweight, have a small form factor, and be weather resistant.

It is therefore an object of the present invention to provide an economical apparatus for electronically controlling an animal.

### SUMMARY OF THE INVENTION

The present invention is directed to an apparatus and method that satisfy the needs for controlling a horse. The horse controlling apparatus adapted to act upon a bridle having features of the present invention includes a remote signal unit. The apparatus further includes an actuation unit that is mechanically coupled to a horse and electronically coupled to the remote signal unit. The actuation unit further includes a control unit, an actuator that is electrically coupled to the control unit, and a battery that is electrically coupled to the control unit and the actuator so that the horse can simultaneously carry the actuation unit, a saddle, and a rider sitting on the saddle. In a preferred embodiment, the actuator may be mechanically coupled to the bridle. In another preferred embodiment, the actuator may be located forward of a saddle, the saddle being attached to the horse. In another preferred embodiment, the control unit and battery may be located behind a saddle, the saddle being attached to the horse. In another preferred embodiment, the actuator may be attached to the saddle. In another preferred embodiment, the control unit may include a programmable controller. In another preferred embodiment, the actuator may include a gear train coupled to the electric motor and bridle. In another preferred embodiment, the apparatus further includes a saddle. In another preferred embodiment, the actuation unit is secured inside the saddle.

An apparatus adapted to act upon a bridle having features of the present invention includes a remote signal unit. The apparatus further includes an actuation unit that is mechanically coupled to a horse and electronically coupled to the remote signal unit. The actuation unit further includes a control unit, an actuator electrically coupled to the control unit, and a battery electrically coupled to the control unit and the actuator so that the actuator applies a control stimulus only to the bridle. In a preferred embodiment, the horse can simultaneously carry the actuation unit, a saddle, and a rider sitting on the saddle.

An apparatus having features of the present invention includes a remote signal unit. The apparatus further includes an actuation unit adjacent to the saddle and electronically coupled to the remote signal unit. The actuation unit further includes a control unit, an actuator electrically coupled to the control unit, and a battery electrically coupled to the control unit and the actuator so that the actuator is housed in a first housing and the control unit and the battery are housed in a second housing.

A method having features of the present invention includes the step of electronically sending a signal from a remote signal unit to an actuation unit. The method further includes the step of receiving the signal at the actuation unit. The method further includes the step of actuating the bridle with the actuation unit based on the signal and other inputs to the actuation unit. In a preferred embodiment, the step of actuating the bridle includes successive pulling and releasing motions applied to the bridle.

The present invention has a number of advantages. One advantage is that the horse may be controlled from a remote location without a line connected to the horse. Another advantage is that the apparatus is simple and has only the required functionality thereby making the apparatus inexpensive and practical to the consumer. Another advantage is that the apparatus may include an actuator that is programmable and therefore repeatable. Another advantage is that the apparatus may be detachable from the saddle. Another advantage is that the apparatus may be secured in part or entirely internal to the saddle so that the saddle form factor is substantially unchanged.

These and other features, aspects, and advantages of the present invention will become better understood with reference to the following description and appended claims and accompanying drawings.

### BRIEF DESCRIPTION OF THE DRAWINGS

FIG. 1 is a pictorial view of a horse outfitted with a control apparatus embodying features of the present invention.

FIG. 2 is a schematic diagram of one version of a remote signal unit and an actuation unit usable in the control apparatus of FIG. 1.

FIG. 2A is a schematic diagram of a second version of an actuation unit usable in the control apparatus of FIG. 1.

FIG. 2B is a schematic diagram of a third version of an actuation unit usable in the control apparatus of FIG. 1.

FIG. 2C is a schematic diagram of a fourth version of an actuation unit usable in the control apparatus of FIG. 1.

FIG. 2D is a schematic diagram of a fifth version of an actuation unit usable in the control apparatus of FIG. 1.

FIG. 3 is a partial pictorial view of a horse outfitted with another version of a control apparatus having features of the invention.

FIG. 4A is a flow chart of a first operating mode according to the invention.

FIG. 4B is a flow chart of a second operating mode according to the invention.

FIG. 4C is a flow chart of a third operating mode according to the invention.

FIG. 4D is a flow chart of a fourth operating mode according to the invention.

### DESCRIPTION OF THE EMBODIMENTS

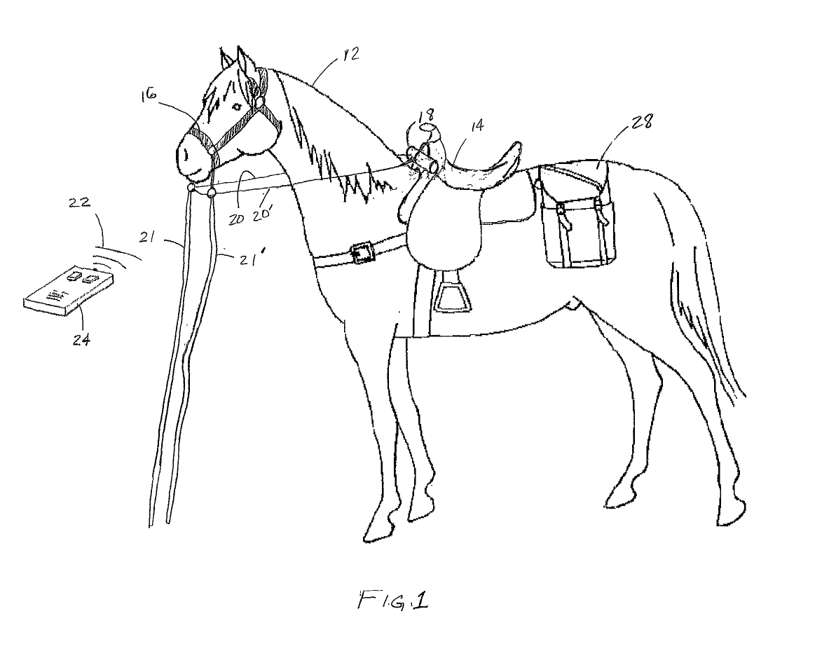

An embodiment of the present invention is illustrated in FIG. 1. In the example of FIG. 1, a horse 12 is fitted with a saddle 14 and a bridle 16. The bridle 16 is connected to an actuation unit 18 with a first line 20 and a second line 20′ so that the actuation unit 18 may apply a control stimulus to the bridle. A first rein 21 and a second rein 21′ may be coupled to the bridle 16. The horse 12 may also be fitted with a saddlebag 28. The actuation unit 18 is electrically coupled to a remote signal unit 24 by a remote signal 22. The actuation unit 18 is mechanically coupled to the first line 20 and the second line 20′.

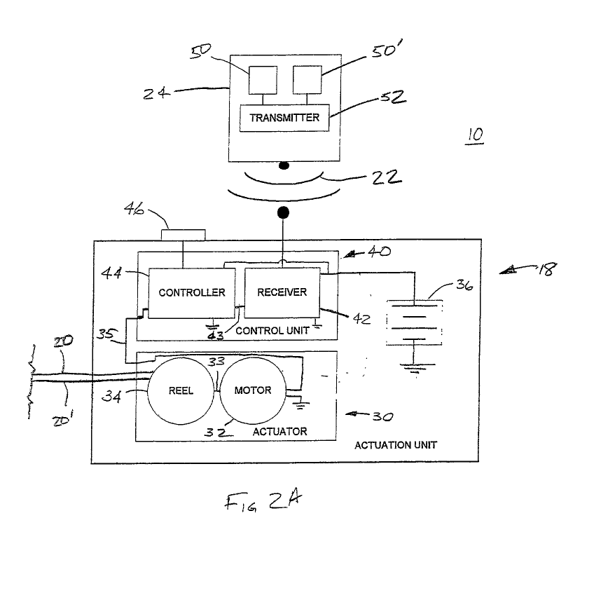

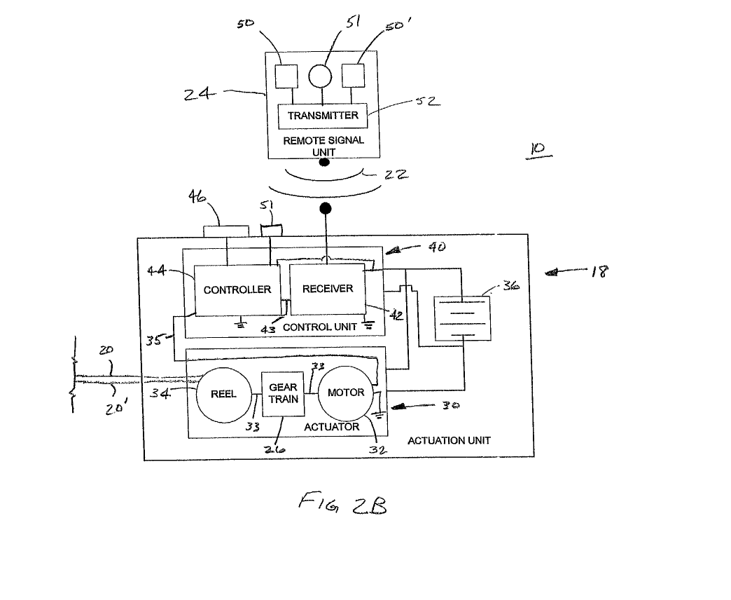

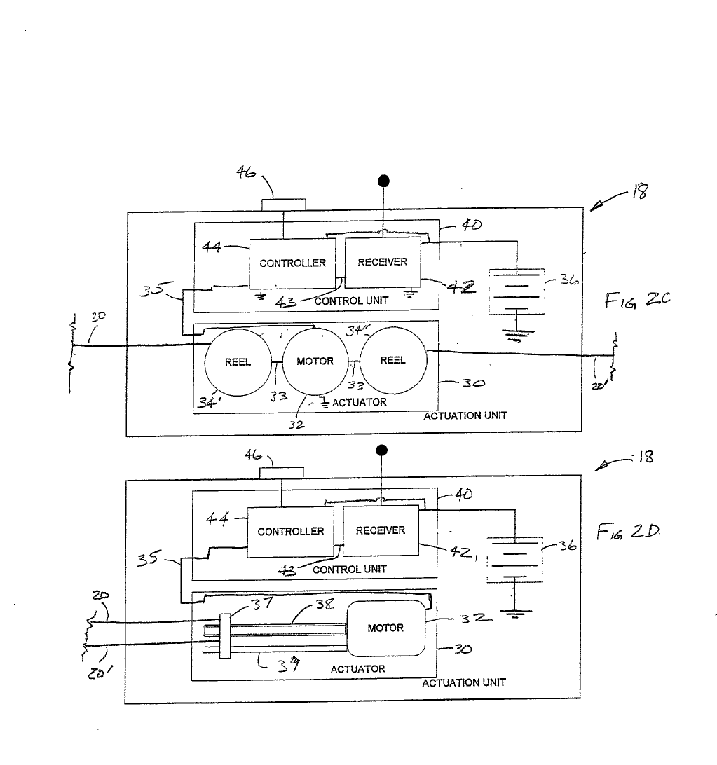

Referring to FIG. 2A, a horse controlling apparatus 10 includes the remote signal unit 24 and the actuation unit 18 coupled by the remote signal 22. The actuation unit 18 includes a control unit 40 for receiving the remote signal 22, and an actuator 30. The control unit 40 and the actuator 30 are powered by a battery 36. The control unit 40 further includes a receiver 42 which receives the remote signal 22. The controller 44 is coupled to the receiver 42 by an input data link 43 and optionally to at least one input switch 46 mounted external to the control unit. The controller 44 is further coupled to the actuator 30 by a motor control link 35. The actuator 30 includes an electric motor 32, connected to a reel 34 by a shaft 33. The lines 20 and 20′ are coupled to the reel 34.

Referring to another version of the invention in FIG. 2B, the actuator 30 includes an electric motor 32, coupled to a reel 34 by a shaft 33 and a gear train 26. The gear train provides a reduction in shaft speed going from the motor 32 to the reel 34 thereby providing increased torque to the reel 34.

Referring to FIG. 2C, the actuator 30 may optionally include an electric motor 32 coupled to a first reel 34′ and a second reel 34″. The first reel 34′ is coupled to the first line 20 and the second reel 34′ is coupled to the second line 20′. In an alternative embodiment, illustrated in FIG. 2D, the actuator 30 includes an electric motor 32 coupled to a threaded shaft 38. A slide 37 is coupled to a rod 39 and to the threaded shaft 38 so that turning the electric motor 32 advances the slide 37 along the threaded shaft 38. The lines 20 and 20′ are coupled to the slide 37.

Referring to FIG. 3, the horse controlling apparatus 10 may be contained in one or more housings attached to the horse 12, or the saddle 14 or both. For instance, FIG. 3 shows how the actuator 30 is attached in front of the saddle 14 in a first housing 25 and the control unit 40 is attached behind the saddle 14 in a second housing 25′. Referring back to FIG. 1, the control unit 40 and battery 36 may alternatively be contained in a saddlebag 28. In either of these configurations, the control unit 40, actuator 30, and battery 36 are readily detachable.

In the embodiment of FIG. 2A, the remote signal unit 24 includes a first button 50, a second button 50′, and a transmitter 52. The first button 50 and second button 50′ may be push type switches. In an alternative embodiment, the transmitter 52 may be a radio frequency (RF) transmitter or an infrared (IR) transmitter. Optionally, the transmitter 52 may be omitted so that the first button 50 and the second button 50′ may be connected by wire to the control unit 40. The remote signal unit 24 may preferably be a small keychain-sized device such as the TX-99K-2 manufactured by Ming Microsystems Inc. In an alternative embodiment illustrated in FIG. 2B, the remote signal unit 24 may include a potentiometer 51 and the actuation unit 18 may include a potentiometer 51 mounted external to a housing.

The receiver 42 may include a radio frequency (RF) receiver or an infrared (IR) receiver. In a preferred embodiment, the RF receiver may be the RE-99 manufactured by Ming Microsystems. The controller 44 may include a programmable microcontroller such as the BASIC Stamp BS2 manufactured by Parallax, Inc.

The entire actuation unit 18 may be contained in one or more housings. The one or more housings may be constructed of a material such as plastic, steel, or aluminum. Impact-resistant, injection-molded plastics such as polycarbonate, ABS, and polysulfone are well suited for this sort of enclosure. The one or more housings may also be constructed to furnish a water-tight seal about the internal components. The one or more housings may be rectangular or cylindrical in shape to enhance manufacturability or to allow easy attachment to the saddle or horse. The housing may also include one or more mounted switches, buttons, or potentiometers. Such devices are useful for selecting a particular operating mode or fine tuning a particular operating mode.

The battery 36 may be a rechargeable battery such as a NiCad or Lithium Ion battery. The lines 20 and 20′ may be made of wire rope, nylon braided rope, or a composite braided rope such as Kevlar®. The bridle 16 normally includes a head stall, a chin strap, and a bit.

Referring to FIG. 3, the saddle 14 typically includes a seat 60, a cantle 62, a tree 64, a horn 66, and a skirt 68. An example of such a saddle is Model #3767-1554 manufactured by Circle Y of Yoakum, Inc. In another embodiment, the control unit 40 or the actuator 30 may be secured inside the saddle 14 so that its external form factor is substantially unchanged from its original shape. This may be accomplished by building the actuator 30, or the control unit 40 into the structure of the seat 60, cantle 62, or tree 64.

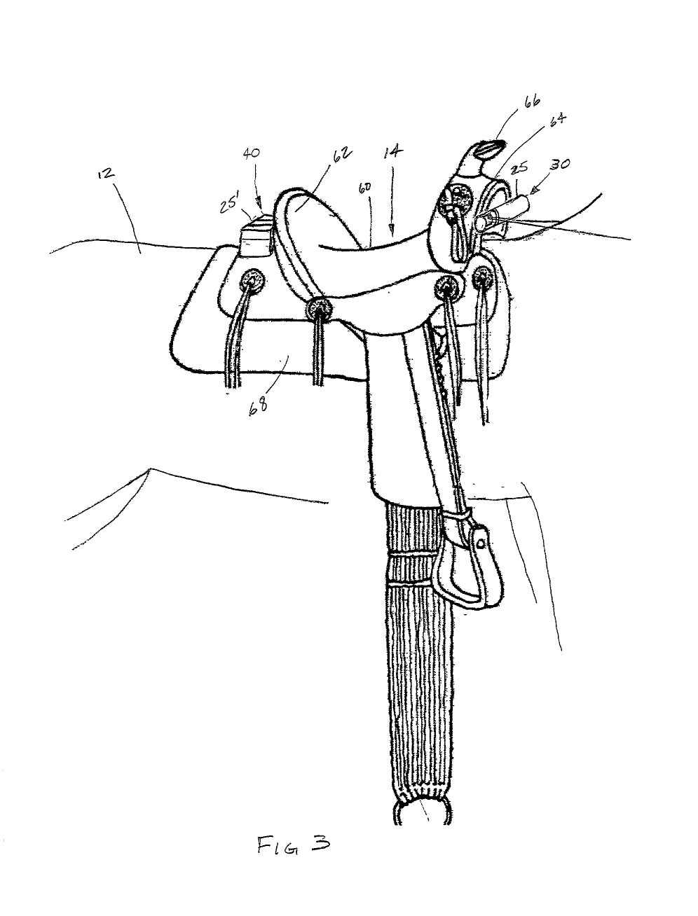

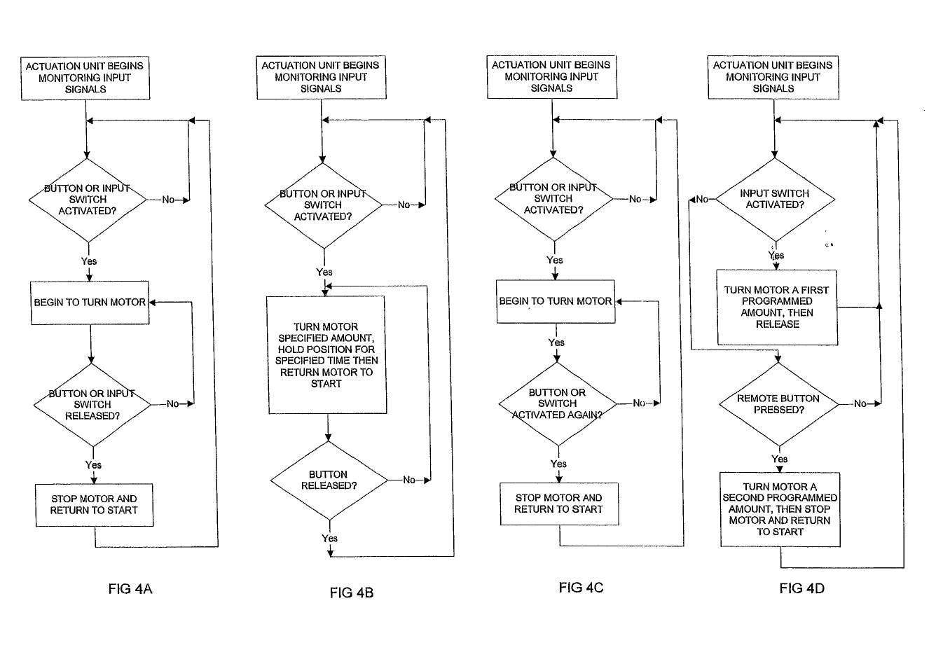

The control apparatus of the present invention may be operated in several modes. For instance, the horse 12 may be stopped or held in a stopped position according to the method illustrated in FIG. 4A. The actuation unit 18 begins monitoring for input signals; specifically for the user to press the button 50, the button 50′, or the input switch 46, The electric motor 32 is provided with power and the actuation unit 18 monitors when the activated button or switch is released at which point the electric motor 32 is stopped and returned to the start position. FIG. 4B illustrates another mode where the system responds to the activated button or switch by turning the electric motor 32 some programmed amount, then holding the position and finally returning the electric motor 32 to its original position. Again, the actuation unit 18 begins monitoring for input signals. When a signal is received, the electric motor 32 turns a programmed amount, holds its position for a programmed time, then returns to the start position. If the button or switch is deactivated at this point, the actuation unit 18 begins monitoring again. Note that the electric motor 32 starts again if the button or switch is activated. FIG. 4C illustrates a third mode where a button or switch activation starts the electric motor 32 and a second button or switch activation stops and reverses the electric motor 32 to its original position. The mode of FIG. 4C may be implemented with two buttons or switches so that one specifically turns the electric motor 32 in one direction and another button or switch turns the electric motor 32 in another direction. Other variations are possible and may be more suitable in certain circumstances. The foregoing may be useful for pleasure riding, ranching, competition, or training operations.

In competition, the actuation unit may be preprogrammed to engage and release the lines automatically followed by a state where the actuation unit waits for further commands from the user as illustrated in FIG. 4D. For instance, in calf roping, the rider may press a button on the actuation unit during a dismount. Doing so may activate a programmed sequence of movements to engage and release the reins in a manner similar to how a jerk-line is used. Unlike the typical jerk-line method, the user may have continued manual control over the horse after dismount through use of the remote signal unit 24. In addition, the programmed control provides a consistent input to the horse.

The previously described versions of the present invention have many advantages. By having an apparatus that works with a typical saddle, the user may more easily use the apparatus with saddles from different manufacturers. Also, by having an apparatus that only acts on or provides a control stimulus to the bridle, the apparatus is simple, small, and inexpensive.

While there has been described what are believed to be the preferred embodiments of the present invention, those skilled in the art will recognize that other and further changes and modifications may be made thereto without departing from the spirit of the invention, and it is intended to claim all such changes and modifications as fall within the true scope of the invention

What is claimed is:

1. A horse controlling apparatus adapted to act upon a bridle comprising:
a) a remote signal unit; and
b) an actuation unit mechanically coupled to a horse and electronically coupled to the remote signal unit, the actuation unit further including:
i) a control unit;
ii) an actuator electrically coupled to the control unit; and
iii) a battery electrically coupled to the control unit and the actuator;
wherein the horse can simultaneously carry the actuation unit, a saddle, and a rider sitting on the saddle.

2. The apparatus of claim 1 wherein the actuator is mechanically coupled to the bridle.

3. The apparatus of claim 2 wherein the actuator is located forward of the saddle, the saddle being attached to the horse.

4. The apparatus of claim 3 wherein the control unit and battery are located behind the saddle, the saddle being attached to the horse.

5. The apparatus of claim 3 wherein the actuator is attached to the saddle.

6. The apparatus of claim 3 wherein the control unit includes a controller that is programmable.

7. The apparatus of claim 3 wherein the actuator includes a gear train coupled to the electric motor and bridle.

8. The apparatus of claim 1 further comprising a saddle.

9. The apparatus of claim 8 wherein the actuation unit is secured inside the saddle.

10. A horse controlling apparatus adapted to act upon a bridle comprising:
a) a remote signal unit; and
b) an actuation unit mechanically coupled to a horse and electronically coupled to the remote signal unit, the actuation unit further including:
i) a control unit;
ii) an actuator electrically coupled to the control unit; and
iii) a battery electrically coupled to the control unit and the actuator;
wherein the actuator applies a control stimulus only to the bridle.

11. The apparatus of claim 10 wherein the horse can simultaneously carry the actuation unit, a saddle, and a rider sitting on the saddle.

12. A horse controlling apparatus comprising:
a) a remote signal unit; and
b) an actuation unit adjacent to the saddle and electronically coupled to the remote signal unit, the actuation unit fiber including:
i) a control unit;
ii) an actuator electrically coupled to the control unit; and
iii) a battery electrically coupled to the control unit and the actuator
wherein the actuator is housed in a first housing and the control unit and the battery are housed in a second housing.

13. A method of controlling a horse comprising the steps of:
a) electronically sending a signal from a remote signal unit to an actuation unit,
b) receiving the signal at the actuation unit, and
c) actuating the bridle with the actuation unit based on the signal and other electronic inputs to the actuation unit.

14. The method of claim 13 wherein actuating the bridle includes successive pulling and releasing motions applied to the bridle.
